(19) United States
(12) Patent Application Publication
(10) Pub. No.: US 2024/0216216 A1
(43) Pub. Date: Jul. 4, 2024

(54) MASSAGING DEVICE

(71) Applicant: SHENZHEN HEZE TECHNOLOGY CO., LTD, Shenzhen (CN)

(72) Inventors: Minchao HE, Shenzhen (CN); Yongqing WANG, Shenzhen (CN); Botian HUANG, Shenzhen (CN)

(21) Appl. No.: 18/091,402

(22) Filed: Dec. 30, 2022

(51) Int. Cl. A61H 23/02

(52) U.S. Cl. CPC A61H 23/0254; A61H 2201/5007; A61H 2201/5097

(57) ABSTRACT

The present disclosure provides a massaging device, which includes a flexible member, defining a first opening and a receiving cavity communicated with the first opening; and a driving assembly, configured to drive the flexible member to reciprocate. The massaging device of the present disclosure has a good massaging effect.

### FIELD

The present disclosure relates to the technical field of massaging equipment, specifically to a massaging device.

### BACKGROUND

With the accelerated pace of life, working pressures on people are increased. After daily working, a person may be tired, various portions of a body may ache. In order to relieve fatigue and soreness, people may take a variety of massaging devices to massage the finger or other portions of the body. However, the massaging device in the related art needs to be operated manually which causing a poor massaging effect.

Therefore, the massaging device in the related art needs to be improved to avoid the above defects.

### SUMMARY

The present disclosure provides a massaging device, which includes a flexible member and a driving assembly configured to drive the flexible member to reciprocate, the flexible member defines a first opening and a receiving cavity communicated with the first opening.

Furthermore, the massaging device includes an inner housing connected with the flexible member. The driving assembly includes, a driving member, a rotating member rotatably connected with the driving member, a fixing frame connected with the inner housing and defining a sliding groove, and a follower connected with the rotating member and slidably received in the sliding groove, the rotating member and the follower drive the flexible member and the inner housing to reciprocate.

Furthermore, the massaging device further includes: a support housing, at least one guiding rod arranged on the support housing and an inner housing received in the support housing, the inner housing is movably connected with the guiding rod, the flexible member is connected with the inner housing, and the driving assembly is configured to drive the flexible member and the inner housing to reciprocate along the guiding rod.

Furthermore, the massaging device further includes an outer housing configured for receiving the flexible member, the driving assembly, the support housing, the guiding rod, and the inner housing, one end of the flexible member is fixed to the inner housing, and another end of the flexible member is fixed to the outer housing; or one end of the flexible member is fixed to the inner housing, and another end of the flexible member is separated from the outer housing.

Furthermore, the massaging device further includes a temperature regulating member. The flexible member defines a receiving groove configured for receiving the temperature regulating member.

Furthermore, the massaging device further includes a vibrating motor. The flexible member defines a receiving groove configured for receiving the vibrating motor.

Furthermore, the massaging device further includes a printed circuit board, and a wireless communication module electrically connected with the printed circuit board to control the driving assembly. The driving assembly is electrically connected with the printed circuit board.

Furthermore, the massaging device further includes an outer housing, the flexible member is received in the outer housing; or at least a portion of the flexible member is exposed from the outer housing.

Furthermore, the massaging device further includes an inner housing connected with the flexible member. The driving assembly includes a driving member, a gear set connected with the driving member, a screw rod connected with the gear set and defining a guiding groove, and a limiting member fixedly connected with the inner housing and extended in the guiding groove, the guiding groove is spirally or aslant defined on the screw rod, the driving member is configured to drive the gear set and the screw rod to rotate, the limiting member is configured to move in the guiding groove and move the inner housing and the flexible member to reciprocate due to an interaction between the limiting member and an inner wall of the guiding groove.

Furthermore, the massaging device further includes a support housing, at least one guiding rod arranged on the support housing, a first seat arranged on the inner housing, and a second seat connected with the first seat, the limiting member is fixedly arranged on the first seat, the first seat and the second seat cooperatively define a receiving space for receiving the screw rod, the second seat and the first seat are configured to reciprocate along the guiding rod.

Furthermore, the screw rod defines at least two guiding grooves extending along different directions, the at least two guiding grooves includes at least one junction, and the limiting member is received in the junction.

Furthermore, the massaging device further includes an inner housing connected with the flexible member. The driving assembly includes a driving member, a worm rotatably connected with the driving member, a turbine engaged with the worm, at least one rotating plate fixedly connected with the turbine, and at least one swing rod connected with the rotating plate, the driving member is configured to drive the worm, the turbine, the rotating plate and the swing rod to rotate, to move the inner housing and the flexible member to reciprocate.

Furthermore, the massaging device further includes an outer housing, at least one guiding rod arranged on the outer housing, and at least one movable seat fixedly connected with the inner housing, the movable seat is slidably connected with the guiding rod, and the flexible member, the inner housing, and the movable seat are configured to reciprocate along the guiding rod.

Furthermore, the massaging device further includes an inner housing connected with the flexible member, a first sleeve, a second sleeve connected with the first sleeve, and a limiting member arranged on the inner housing, the second sleeve and the first sleeve cooperatively define a guiding groove, the guiding groove is spirally or aslant defined between the first sleeve and the second sleeve, the inner housing is received in the first sleeve and the second sleeve, the driving assembly is configured to drive the first sleeve and the second sleeve to rotate, the limiting member is configured to move in the guiding groove and move the inner housing and the flexible member to reciprocate due to an interaction between the limiting member and an inner wall of the guiding groove.

Furthermore, the driving assembly includes a driving member, a first gear rotatably connected with the driving member, and a second gear engaged with the first gear and connected with the first sleeve, the driving member is configured to drive the first gear and the second gear to rotate, to move the first sleeve, the second sleeve, the inner housing, and the flexible member to reciprocate.

Furthermore, the inner housing defines at least one limiting groove, the limiting member is received in the limiting groove. The massaging device further includes an outer housing, the outer housing includes at least one limiting column, the limiting column is received in the limiting groove, the inner housing is slidably connected with the outer housing by a cooperation between the limiting groove and the limiting column.

Furthermore, the first sleeve includes a first curved edge, the second sleeve is internally provided with a second curved edge, when the first sleeve is received in the second sleeve, the first curved edge and the second curved edge cooperatively define the guiding groove.

Furthermore, the massaging device further includes a fixing housing, and a movable frame connected with the inner housing, the movable frame and the inner housing are movably received in the fixing housing, the driving assembly is arranged on the movable frame and configured to drive the movable frame and inner housing to reciprocate.

Furthermore, the fixing housing defines a sliding groove. The driving assembly includes a driving member mounted on the movable frame, a worm connected with the driving member, a turbine connected with the worm, a first gear connected with the turbine, a second gear engaged with the first gear, and a follower arranged on the second gear, the follower is slidably received in the sliding groove to move the inner housing, the flexible member and the movable frame to reciprocate.

Furthermore, the movable frame includes a first sub movable frame configured for mounting the first gear and the second gear, and a second sub movable frame detachably connected with the first sub movable frame, the second sub movable frame is configured for mounting the driving member and the worm. The massaging device further includes at least one guiding member fixedly connected with the fixing frame, the guiding member defines a sliding groove, an edge of first sub movable frame and/or an edge of second sub fixing frame is movably received in the sliding groove.

In the technical solution of the present disclosure, the driving assembly can drive the flexible assembly to reciprocate without manual operation, so as to massage the finger or other portions of user, the massaging effect is good.

### BRIEF DESCRIPTION OF THE DRAWINGS

Implementations of the present disclosure will now be described, by way of embodiment, with reference to the attached FIG.s. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a structure diagram of a massaging device according to a first embodiment of the present disclosure.

FIG. 2 is another structure diagram of the massaging device of FIG. 1.

FIG. 3 is a cross sectional diagram of the massaging device of FIG. 1.

FIG. 4 is another cross sectional diagram of the massaging device of FIG. 1.

FIG. 5 is a structure diagram of a part of the massaging device of FIG. 1.

FIG. 6 is an exploded diagram of the part of the massaging device of FIG. 5.

FIG. 7 is another exploded diagram of the part of the massaging device of FIG. 5.

FIG. 8 is a structure diagram of a massaging device according to a second embodiment of the present disclosure.

FIG. 9 is a cross sectional diagram of the massaging device of FIG. 8.

FIG. 10 is a structure diagram of a part of the massaging device of FIG. 9.

FIG. 11 is an exploded diagram of the part of the massaging device of FIG. 10.

FIG. 12 is a structure diagram of a screw rod, a fixing member, and a fixing seat of the massaging device of FIG. 9.

FIG. 13 is an exploded diagram of the screw rod, the fixing member, and the fixing seat of the massaging device of FIG. 9.

FIG. 14 is a cross sectional diagram of a massaging device according to a third embodiment of the present disclosure.

FIG. 15 is a structure diagram of a flexible member, an inner housing, and a driving assembly of the massaging device of FIG. 14.

FIG. 16 is a structure diagram of a massaging device according to a fourth embodiment of the present disclosure.

FIG. 17 is a cross sectional diagram of the massaging device of FIG. 16.

FIG. 18 is an exploded diagram of the massaging device of FIG. 16.

FIG. 19 is a structure diagram of a second sleeve of the massaging device of FIG. 17.

FIG. 20 is another structure diagram of a second sleeve of the massaging device of FIG. 17.

FIG. 21 is a structure diagram of a mounting frame of the massaging device of FIG. 17.

FIG. 22 is a structure diagram of a massaging device according to a fifth embodiment of the present disclosure.

FIG. 23 is an exploded diagram of the massaging device of FIG. 22.

FIG. 24 is an exploded diagram of a part of the massaging device of FIG. 23.

FIG. 25 is similar to FIG. 24, but shown from another view.

FIG. 26 is a structure diagram of an inner housing and a movable frame of the massaging device of FIG. 23.

FIG. 27 is a structure diagram of a guiding member of the massaging device of FIG. 23.

The realization of the aim, functional characteristics, advantages of the present disclosure are further described specifically with reference to the accompanying drawings and embodiments.

### DETAILED DESCRIPTION

It will be appreciated that for simplicity and clarity of illustration, where appropriate, reference numerals have been repeated among the different FIG.s to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion in the so-described combination, group, series, and the like. the present disclosure is illustrated by way of example and not by way of limitation in the FIG.s of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the application, “a plurality of” means two or more, unless otherwise specifically defined.

The present disclosure provides a massaging device 100a according to a first embodiment. The massaging device 100a is used to accommodate an electronic device and/or cooperate with an external wireless charger to wirelessly charge the electronic device. Optionally, the electronic device may be mobile phone, pad and other mobile devices. The first embodiment takes the mobile phone as an example.

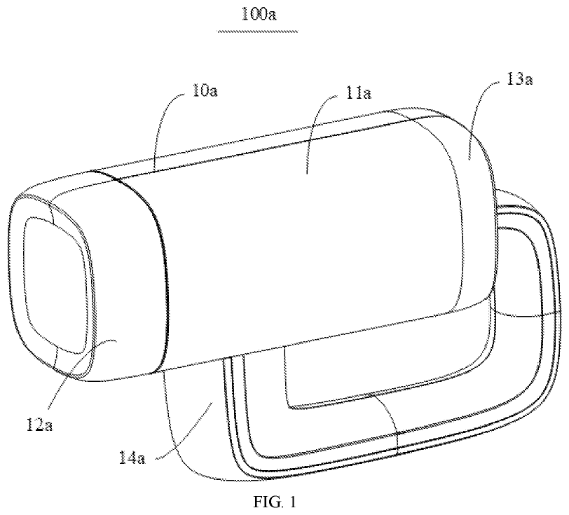

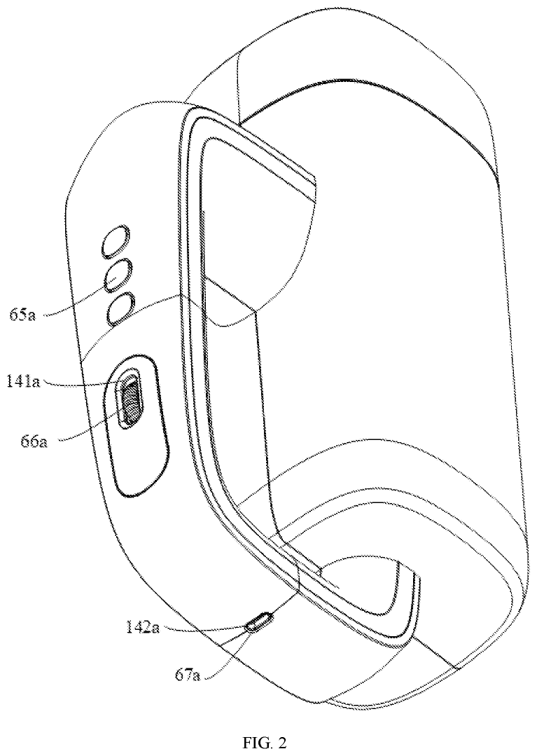

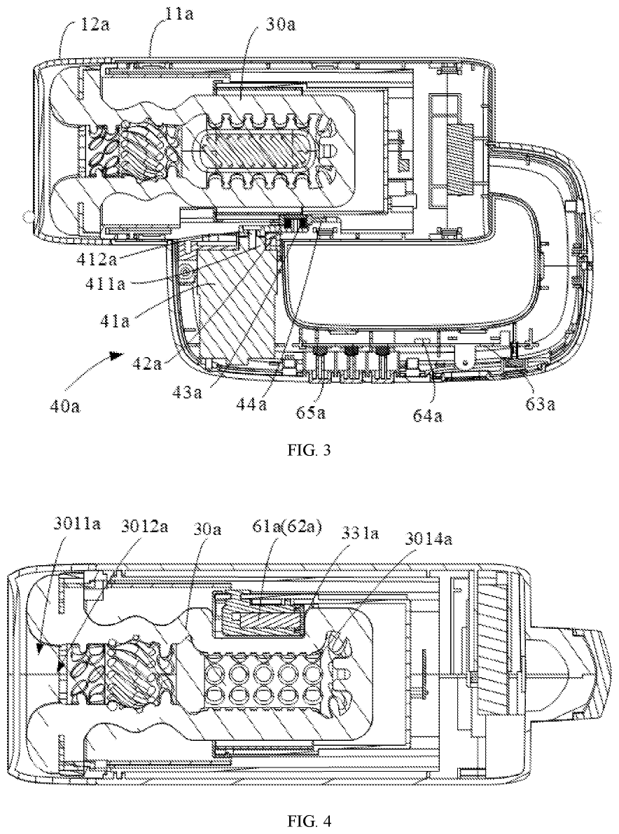

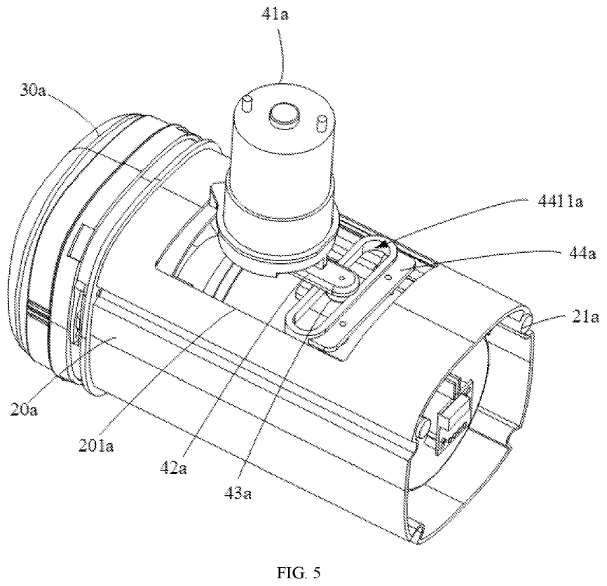

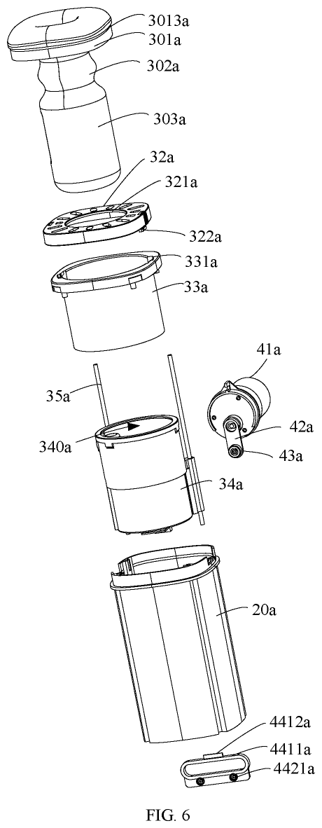

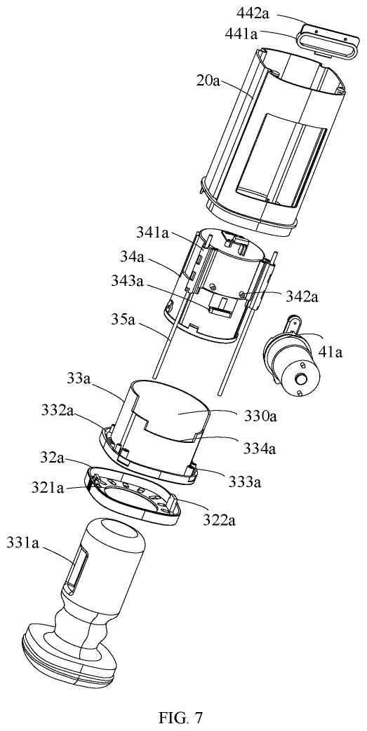

Referring to FIGS. 1-7, the present disclosure provides a massaging device 100a according to a first embodiment. The massaging device 100a is used to massage user's fingers, or other parts of the body. The massaging device 100a is gun-shaped, and the massaging device 100a may also have other shapes according to the actual needs.

The massaging device 100a includes an outer housing 10a, a support housing 20a, a flexible member 30a, an inner housing 34a, and a driving assembly 40a, the support housing 20a, the flexible member 30a, the inner housing 34a, and the driving assembly 40a are all received in the outer housing 10a. The flexible member 30a defines a first opening 3011a and a receiving cavity 3012a communicated with the first opening 3011a, user can put his finger in the receiving cavity 3012a after passing through the first opening 3011a. The driving assembly 40a may drive the support housing 20a the inner housing 34a, and the flexible member 30a to reciprocate, so as to massage the finger.

The outer housing 10a includes two sub housings 11a, two front covers 12a, and two back covers 13a, the sub housings 11a, the front covers 12a, and the back covers 13a enclose a receiving space (not labeled) for receiving the support housing 20a, the inner housing 34a, the flexible member 30a, and the driving assembly 40a. The outer housing 10a further includes a handle 14a connected with the sub housing 11a and the back cover 13a. The flexible member 30a is received in the sub housings 11a and the front covers 12a, when the front covers 12a is separated from the sub housings 11a, the flexible member 30a is exposed from the sub housings 11a.

In an embodiment, a first end of the flexible member 30a is fixed to the inner housing 34a, and a second end of the flexible member 30a is fixed to the sub housing 11a, specifically, the second end of the flexible member 30a is fixed to an end of the sub housing 11a adjacent to the front cover 12a. In another embodiment, a first end of the flexible member 30a is fixed to the inner housing 34a, and a second end of the flexible member 30a is separated from the outer housing 10a. The flexible member 30a is received in the outer housing 10a; or at least a portion of the flexible member 30a is exposed from the outer housing 10a.

The driving assembly 40a includes a driving member 41a received in the handle 14a, a rotating member 42a rotatably connected with the driving member 41a and being capable of swinging under an action of the driving member 41a, a follower 43a connected with the rotating member 42a, and a fixing frame 44a connected with the support housing 20a, the fixing frame 44a defines a sliding groove 4411a, the follower 43a is slidably received in the sliding groove 4411a under an action of the rotating member 42a to move the support housing 20a and the flexible member 30a to reciprocate. An output shaft 411a of the driving member 41a is extended in the sub housings 11a and connected with a first end of the rotating member 42a by a fixing member 412a. The support housing 20a defines a through hole 201a, the follower 43a and the fixing frame 44a are received in the through hole 201a. The driving member 41a may be a motor. The follower 43a may be a bearing.

The flexible member 30a includes a first portion 301a, a second portion 302a, and a third portion 303a, a size of the first section 301a is greater than a size of the third portion 303a, and the size of the third portion 303a is greater than a size of the second portion 302a. The first portion 301a defines the first opening 3011a, the first section 301a, the second portion 302a, and the third portion 303a enclose the receiving cavity 3012a. The flexible member 30a further includes at least one massaging protrusion 3014a received in the receiving cavity 3012a, the shape and position of the massaging protrusion 3014a may be designed according to the actual needs.

The first section 301 further defines a first receiving groove 3013a around a circumference of the first section 301. The massaging device 100a further includes a connecting member 32a partially received in the first receiving groove 3013a, a support member 33a clamped with the connecting member 33a, the inner housing 34a movably received in the support member 33a, and at least one guiding rod 35a. The support housing 20a and the inner housing 34a are movably connected to the guiding rod 35a. The support member 33a defines a receiving cavity 330a, the inner housing 34a is movably received in the receiving cavity 330a. The inner housing 34a defines a third receiving groove 340a for receiving the third portion 303a of the flexible member 30a.

A middle portion of the connecting member 32a defines a first through hole (not labeled), a periphery 3201a of the through hole is received in the first receiving groove 3013a to connect the flexible member 30a with the connecting member 32a. A side of the connecting member 32a is protruded with at least one clamping portion 322a, the support member 33a includes at least one clamping groove 331a, the clamping portion 322a is clamped in the clamping groove 331a to connect the support member 33a with the connecting member 32a. A side of the support member 33a defines a second receiving groove 332a, at least one first mounting seat 333a is arranged in the receiving groove 332a, preferably the first mounting seat 333a is extended out of the second receiving groove 332a. The inner housing 34a includes at least one connecting element 341a, the support housing 20a further includes at least one second mounting seat 21a. The driving assembly 30a further includes at least one guiding rod 35a, one end of the guiding rod 35a is fixedly connected with the first mounting seat 333a, and another end is fixedly connected with the second mounting seat 21a. The connecting element 341a is movably connected with the guiding rod 35a, so the inner housing 34a and the flexible member 20a are movably connected with the guiding rod 35a. The first connecting element 341a defines a through hole, the guiding rod 35a is received in the through hole. The second mounting seat 21a defines a receiving hole with an end closed, the closed end can be used to limit a moving distance of the inner housing 34a.

The inner housing 34a further includes at least one fixing element 342a, and a limiting element 343a. The fixing frame 44a further includes a sliding portion 441a defining the sliding groove 4411a, and a fixing portion 442a connected with the sliding portion 441a, and the fixing portion 442a has at least one fixing hole 4421a, the fixing element 342a is received in the fixing hole 4421a to connect the inner housing 34a with the fixing frame 44a. The sliding portion 441a is protruded with the a stopping plate 4412a, the stopping plate 4412a is stopped by the limiting element 343a to limit a moving distance of the inner housing 34a. The support member 33a defines a notch 334a communicated with the receiving cavity 330a, and the notch 334a is used to facilitate a movement of the fixing frame 44a.

The massaging device 100a further includes a temperature regulating member 61a, an outer surface of the third portion 303a of the flexible member 30a defines a third receiving groove 331a configured for receiving the temperature regulating member 61a. The temperature regulating member 61a may be a semiconductor chilling plate, a heating coil, a heating plate, a heating strip, or the like.

The massaging device 100a further includes a vibrating motor 62a, the vibrating motor 62a can be received in the third receiving groove 331a or received in another receiving groove (not shown). In another embodiment, the temperature regulating member 61a or the vibrating motor 62a is arranged on the support housing 20a and attached with the flexible member 30a; in a further embodiment, the temperature regulating member 61a or the vibrating motor 62a is arranged in the flexible member 30a.

The massaging device 100a further includes a printed circuit board 63a, a wireless communication module 64a, at least one operating button 65a, an adjusting member 66a, an interface 67a, and a battery (not labeled). The wireless communication module 64a may be a bluetooth module or a WiFi module. The battery, the driving assembly 40a, the temperature regulating member 61a, the vibrating motor 62a, the wireless communication module 64a, the operating button 65a, the adjusting member 66a, and the interface 67a are electrically connected with the printed circuit board 63a. The adjusting member 66a is exposed from a first through hole 141a defined in the handle 14a, and configured to adjust a massaging intensity of the massaging device 100a, a temperature in the flexible member 30a, or a vibrating intensity. The interface 67a is exposed from a second through hole 142a defined in the handle 14a.

In the technical solution of the present disclosure, the driving assembly 40a can drive the flexible assembly 30a to reciprocate without manual operation, so as to massage the finger, the massaging effect is good.

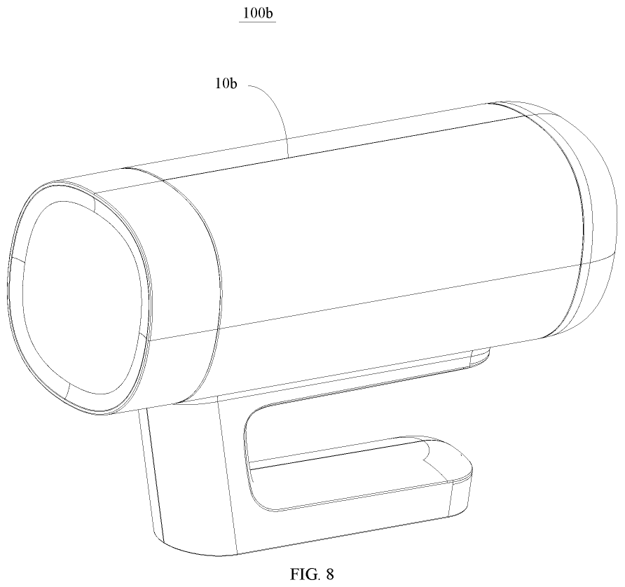

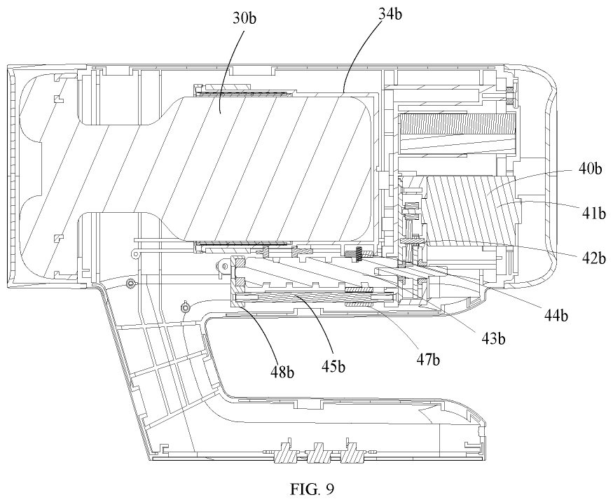

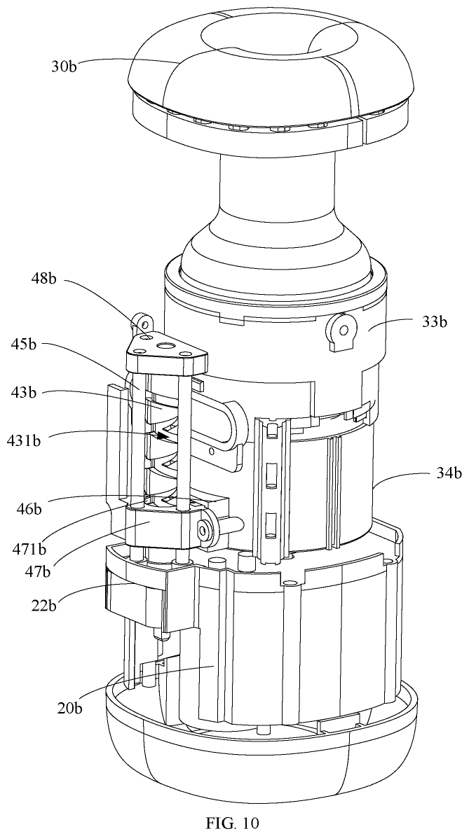

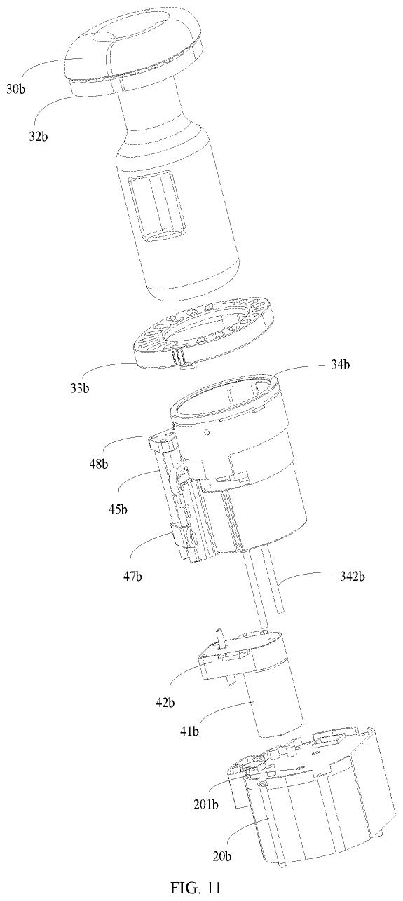

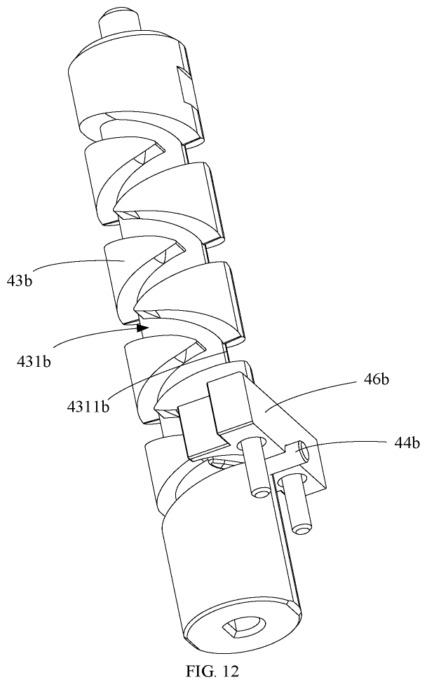

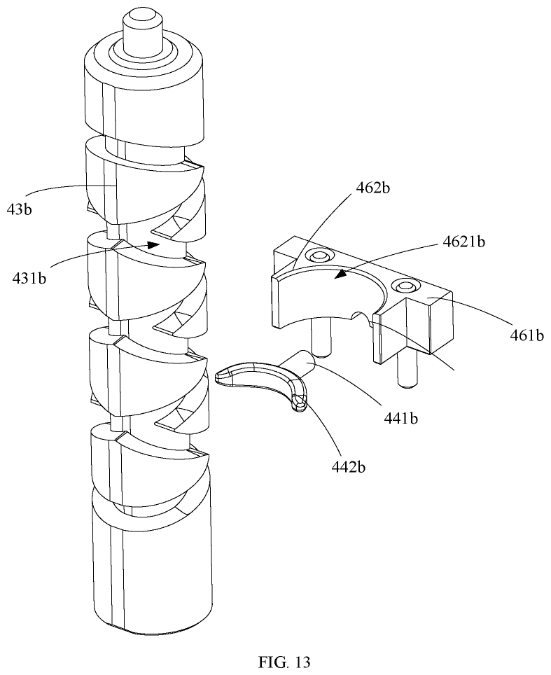

Referring to FIGS. 8-13, the present disclosure further provides a massaging device 100b according to a second embodiment. The massaging device 100b is similar to the massaging device 100a in structure, the differences between the two devices include: (a) the connecting member 32b is separated from the support member 33b; (b) the inner housing 34b is movably relative to the support member 33b and stopped by the support member 33b; (c) the driving assembly 40b includes a driving member 41b, a gear set 42b connected with the driving member 41b, a screw rod 43b connected with the gear set 42b and defining at least one guiding groove 431b, a limiting member 44b fixedly connected with the inner housing 34b and extended in the guiding groove 431b, the guiding groove 431b is spirally or aslant defined on the screw rod 43b, the driving member 41b is configured to drive the gear set 42b and the screw rod 43b to rotate, the limiting member 44b is configured to move in the guiding groove 431b and move the inner housing 34b and the flexible member 30b to reciprocate due to an interaction between the limiting member 44b and an inner wall of the guiding groove 431b; (d) at least one guiding rod 45b is arranged on the support housing 20b, a first seat 46b is arranged on the inner housing 34b, the limiting member 44b is fixedly arranged on the first seat 46b, a second seat 47b is connected with the first seat 46b to define a receiving space 471b for receiving the screw rod 43b, the second seat 47b and the first seat 46b are configured to reciprocate along the guiding rod 45b.

In one embodiment, the screw rod 43b defines two guiding grooves 431b extending along different directions, the two guiding grooves 431b are spirally or aslant defined on the screw rod 43b, the two guiding grooves 431b are communicated with each other and form at least one junction (not labeled). The limiting member 44b includes a connecting portion 441b and a fixing portion 442b connected with the connecting portion 441b, the connecting portion 441b is connected with the first seat 46b. A shape of the limiting member 44b is matched with that of the junction 4311b of the two guiding grooves 431b. The first seat 46b includes a connecting plate 461b connected with the inner housing 34b and a curved portion 462b defining a curved groove 4621b, the second seat 47b also defines a curved groove (not labeled), so the first seat 46b and the second seat 47b can cooperatively define the receiving space 471b, and the screw rod 43b is rotatably received in the receiving space 471b. The first seat 46b further defines a notch 463b communicated with the curved groove 4621b, the connecting portion 441b is fixedly received in the notch 463b.

The support housing 20b is arranged with at least one guiding rod 342b, in detail, the support housing 20b defines at least one receiving hole 201b, the guiding rod 342b is fixedly received in the receiving hole 201b. The inner housing 34b is slidably connected with the guiding rod 342b, in detail, the inner housing 34b defines at least one through hole, and the guiding rod 342b is received in the through hole. The support housing 20b is further arranged with a support 22b, an end of the guiding rod 45b is fixedly arranged in the support 22b.

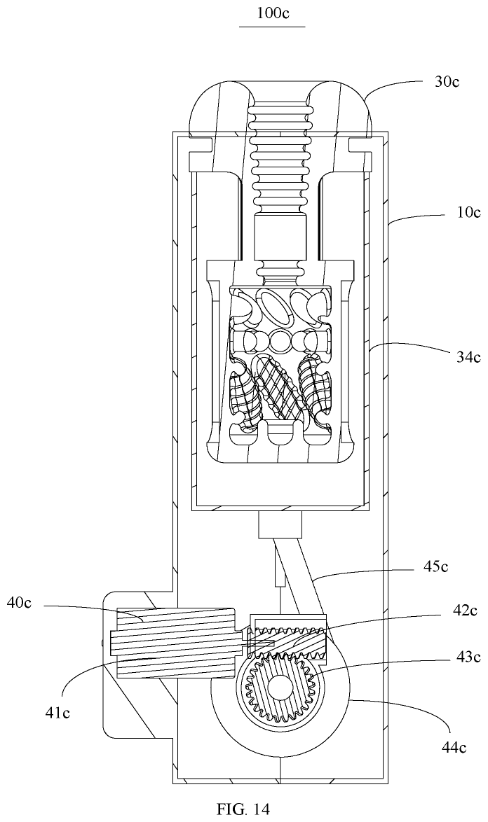

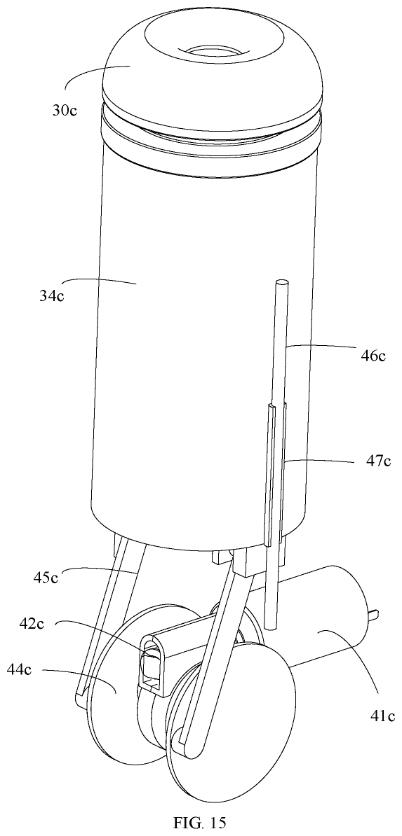

Referring to FIGS. 14-15, the present disclosure further provides a massaging device 100c according to a third embodiment. The massaging device 100c is similar to the massaging device 100a in structure, the differences between the two devices include: (a) the driving assembly includes a driving member 41c, a worm 42c rotatably connected with the driving member 41c, a turbine 43c engaged with the worm 42c, at least one rotating plate 44c fixedly connected with the turbine 43c, and at least one swing rod 45c connected with the rotating plate 44c, the driving member 41c is configured to drive the worm 42c, the turbine 43c, the rotating plate 44c and the swing rod 45c to rotate, to move the inner housing 34c and the flexible member 30c to reciprocate; (b) at least one guiding rod 46c is arranged on the outer housing 10c, at least one movable seat 47c is fixedly connected with the inner housing 34c, the movable seat 47c is slidably connected with the guiding rod 46c, and the flexible member 30c, the inner housing 34c, and the movable seat 47c are configured to reciprocate along the guiding rod 46c; (c) the flexible member 30c is exposed from the outer housing 10c.

The massaging device 100c does not include the connecting member and the support member as described in the first embodiment, the flexible member 30c is movably received in the outer housing 10c and fixedly connected with the inner housing 34c.

The worm 42c is parallel to an output shaft of the driving member 41c, and an axis of the turbine 43c is perpendicular to that of the worm 42c. The turbine 43c has two ends, and each end of the turbine 43c is connected with one rotating plate 44c, and each rotating plate 44c is fixedly connected with one swing rod 45c, in this way, the swing rod 45c can rotate to move the inner housing 34c and the flexible housing 30c to reciprocate along the guiding rod 46c. In detail, the rotating plate 44c is circular shaped, and the swing rod 45c is arranged on a side of the rotating plate 44c away from the driving member 41c.

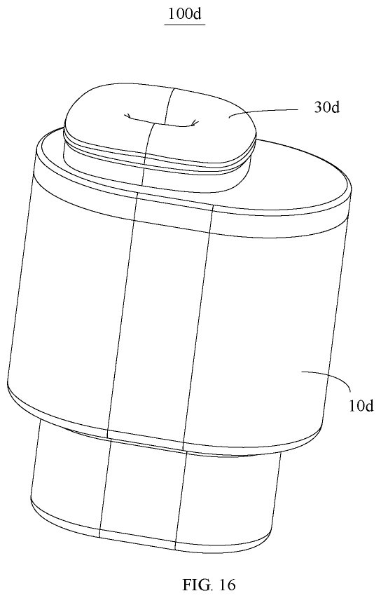

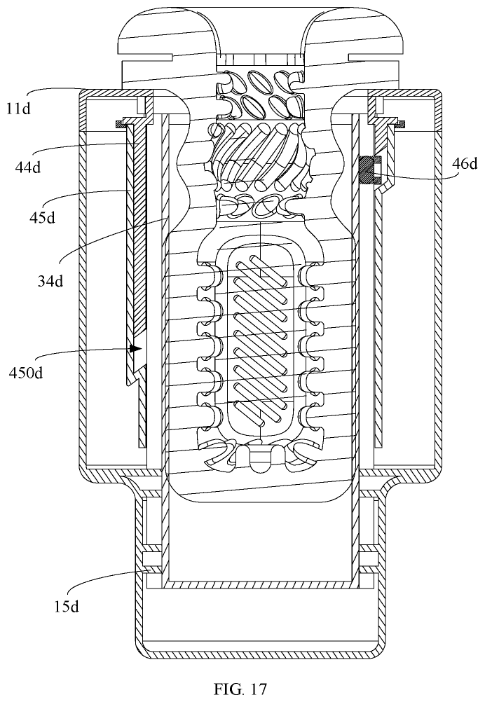

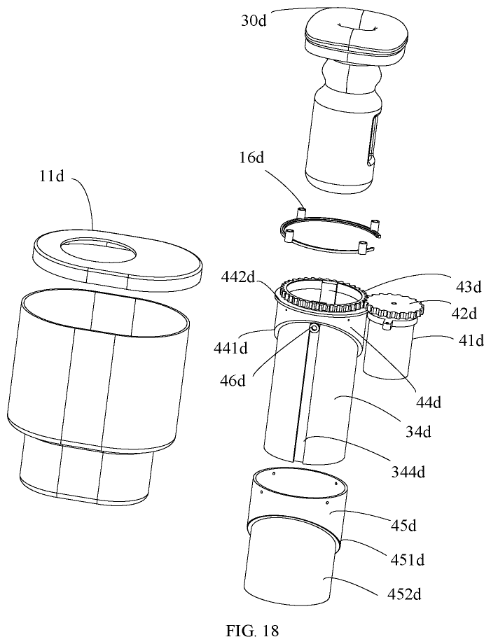

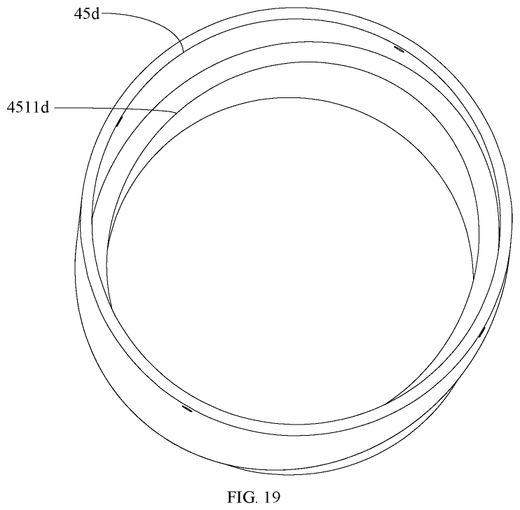

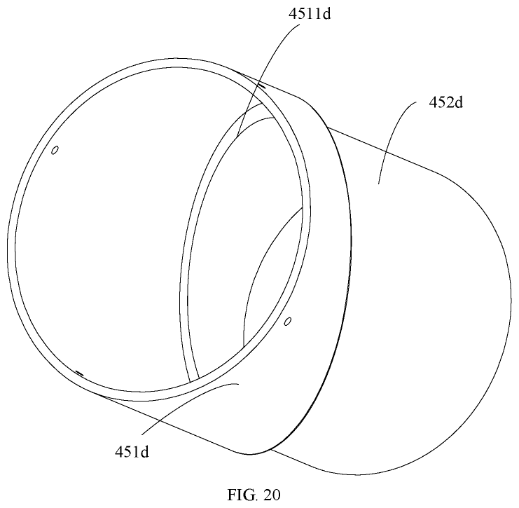

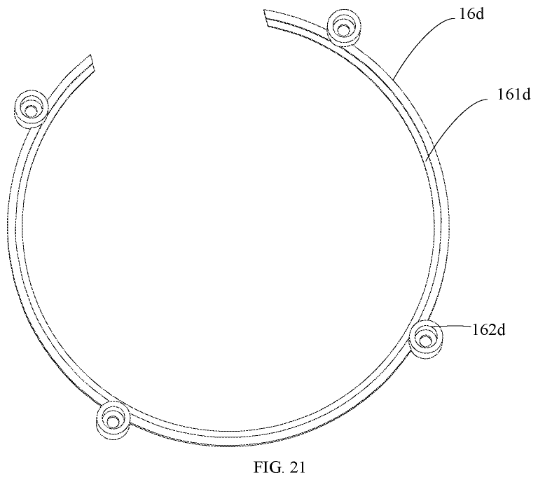

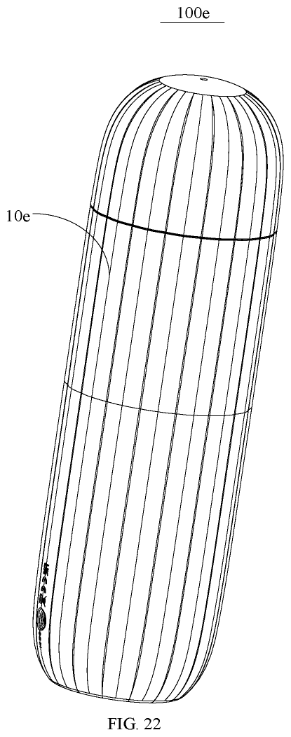

Referring to FIGS. 16-21, the present disclosure further provides a massaging device 100d according to a fourth embodiment. The massaging device 100d is similar to the massaging device 100a in structure, the differences between the two devices include: (a) the driving assembly 40d includes a driving member 41d arranged in the outer housing 10d, a first gear 42d rotatably connected with the driving member 41d, a second gear 43d engaged with the first gear 42d, a first sleeve 44d connected with the second gear 43d, a second sleeve 45d connected with the first sleeve 44d, and a limiting member 46d arranged on the inner housing 34d, the first sleeve 44d is received in the second sleeve 45d, and the first sleeve 44d and the second sleeve 45d cooperatively defines a guiding groove 450d, the guiding groove 450d is aslant defined between the first sleeve 44d and the second sleeve 45d, the limiting member 46d is extended in the guiding groove 450d and enable the inner housing 34d and the flexible member 30d to reciprocate along an up-down direction under an interaction between the limiting member 46d and an inner wall of the guiding groove 450d.

The massaging device 100d further includes a mounting frame 16d connected with the top cover 11d of the outer housing 10d. The mounting frame 16d includes a step 161d, and at least one connecting column 162d arranged along a periphery of the mounting frame 16d, the connecting column 162d is fixedly connected with the top cover 11d. The first sleeve 44d includes a protrusion 442d, the protrusion 442d is rotatably arranged on the step 161d.

The first sleeve 44d is substantially columnar shaped, and includes a first curved edge 441d, the second sleeve 45d includes is substantially columnar shaped and protruded with a first sleeving portion 451d sleeved around the first sleeve 44d, and a second sleeving portion 452d sleeved around the flexible member 30d. A diameter of the first sleeving portion 451d is greater than that of the second sleeving portion 452d, and the first sleeving portion 451d is internally provided with a second curved edge 4511d, when the first sleeve 44d is received in the first sleeving portion 451d, the first curved edge 441d is matched with the second curved edge 4511d in shape, the first curved edge 441d and the second curved edge 4511d cooperatively define the guiding groove 450d.

The inner housing 34d defines at least one limiting groove 344d, an inner wall of the outer housing 10d is protruded with at least one limiting column 111d received in the limiting groove 344d, and the inner housing 34d is slidably connected with the inner housing 10d in an up-down direction by the limiting groove 344d and the limiting column 111d. The limiting member 46d is received in the limiting groove 344d.

When the driving member 41d works, the first gear 41d and the second gear rotate to bring the first sleeve 44d and the second sleeve 45d to rotate simultaneously, the limiting member 46d is slid in the limiting groove 344d from a top end of the guiding groove 450d to a bottom end of the guiding groove 450d, so the interaction between the limiting member 46d and the inner wall of the guiding groove 450d enables the flexible member 30d and the inner housing 34a to reciprocate along the up-down direction.

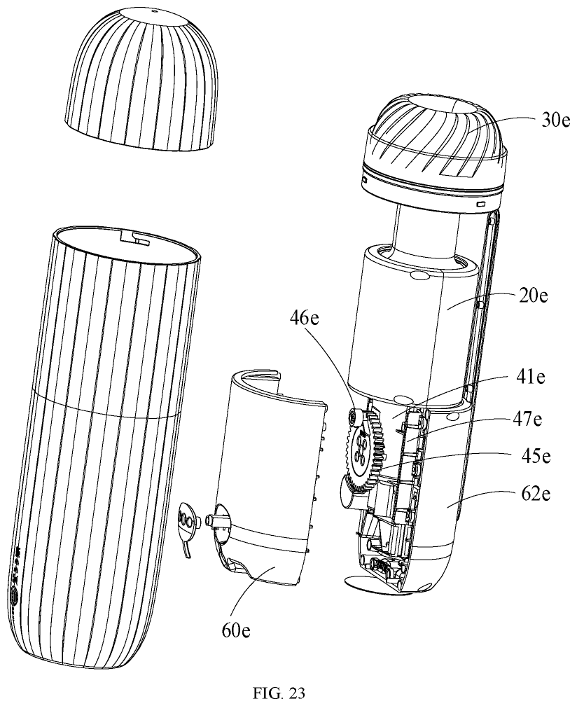

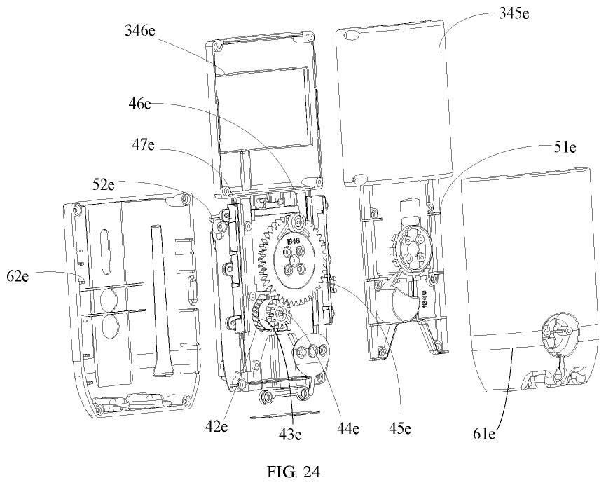

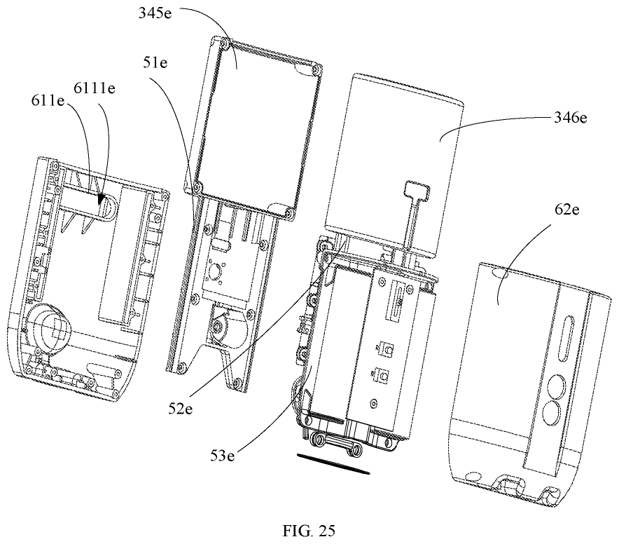

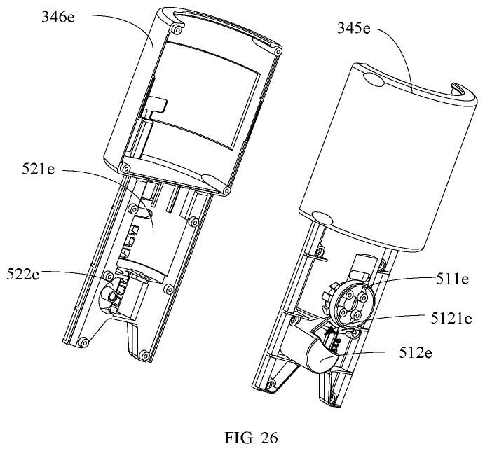

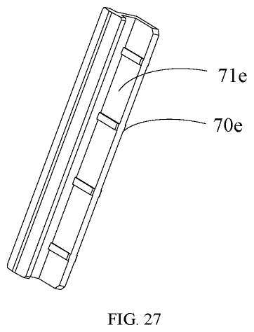

Referring to FIGS. 22-27, the present disclosure further provides a massaging device 100e according to a fifth embodiment. The massaging device 100e is similar to the massaging device 100a in structure, the differences between the two devices include: (a) the massaging device 100e further includes a fixing housing 60e, and a movable frame 50e connected with the inner housing 34e, the movable frame 50e is movably received in the fixing housing 60e; (b) the driving assembly 40e includes a driving member 41e mounted on the movable frame 50e, a worm 42e connected with an output shaft of the driving member 41e, a turbine 43e connected with the worm 42e, a first gear 44e connected with the turbine 43e, a second gear 45e engaged with the first gear 44e, and a follower 46e arranged on an edge of the second gear 45e, the fixing housing 60e includes a sliding groove 6111e, the follower 46e is slidably received in the sliding groove 6111e to bring the inner housing 34e, the flexible member 30e and the movable frame 50e to reciprocate along the up-down direction.

The fixing housing 60e includes a first sub fixing housing 61e and a second sub fixing housing 62e detachably connected with the first sub fixing housing 61e. The first sub fixing housing 61e includes a receiving portion 611e, the receiving portion 611e is cylindrical shaped and defines the sliding groove 6111e extended along a direction perpendicular to an axis of the fixing housing 60e.

The inner housing 34e includes a first sub inner housing 345e and a second sub inner housing 346e detachably connected with the first sub inner housing 345e. The movable frame 50e is movably received in the fixing frame 60e, and includes a first sub movable frame 51e, a second sub movable frame 52e detachably connected with the first sub movable frame 51e, and a third sub movable frame 53e. The first sub movable frame 51e is fixedly connected with the first sub inner housing 345e, and the second sub movable frame 52e is fixedly connected with the second sub inner housing 346e. The third sub fixing frame 53e is arranged on a side of the second sub fixing frame 52e away from the first sub fixing frame 51e, and used to mount the printed circuit board, the battery, and other components.

The driving assembly 40e is mounted on the movable frame 50e. The first sub movable frame 51e includes a first mounting portion 511e used to mount the second gear 45e, and a second mounting portion 512e used to mount the first gear 44e, the follower 46e is mounted on a side of the second gear 45e away from the fixing mounting portion 511e. The second sub fixing frame 52e includes a third mounting portion 521e used to mount the driving member 41e, and a fourth mounting portion 522e used to mount the worm 42e, a through hole 5121e is defined in the first sub movable frame 51e, so the turbine 43e is received in the through hole 5121e and connects the worm 42e with the first gear 44e.

The massaging device 100e further includes at least one guiding member 70e, the guiding member 70e includes a sliding groove 71e extended in an axis of the guiding member 70e. The guiding member 70e is fixedly connected with the fixing frame 60e, an edge of first sub movable frame 51e and/or an edge of second sub fixing frame 52e is movably received in the sliding groove 71e.

The above description is merely some embodiments. It should be noted that for one with ordinary skills in the art, improvements can be made without departing from the concept of the present disclosure, but these improvements shall fall into the protection scope of the present disclosure.

What is claimed is:

1. A massaging device, comprising:
a flexible member, defining a first opening and a receiving cavity communicated with the first opening; and
a driving assembly, configured to drive the flexible member to reciprocate.

2. The massaging device according to claim 1, wherein
the massaging device comprises an inner housing connected with the flexible member; and
the driving assembly comprises:
a driving member;
a rotating member, rotatably connected with the driving member;
a fixing frame, connected with the inner housing and defining a sliding groove; and
a follower, connected with the rotating member and slidably received in the sliding groove, and the rotating member and the follower drive the flexible member and the inner housing to reciprocate.

3. The massaging device according to claim 1, further comprising:
a support housing;
at least one guiding rod, arranged on the support housing; and
an inner housing, received in the support housing, the inner housing is movably connected with the guiding rod, the flexible member is connected with the inner housing, and the driving assembly is configured to drive the flexible member and the inner housing to reciprocate along the guiding rod.

4. The massaging device according to claim 3, further comprising an outer housing configured for receiving the flexible member, the driving assembly, the support housing, the guiding rod, and the inner housing, wherein
one end of the flexible member is fixed to the inner housing, and another end of the flexible member is fixed to the outer housing; or
one end of the flexible member is fixed to the inner housing, and another end of the flexible member is separated from the outer housing.

5. The massaging device according to claim 1, wherein
the massaging device further comprises a temperature regulating member; and
the flexible member defines a receiving groove configured for receiving the temperature regulating member.

6. The massaging device according to claim 1, wherein
the massaging device further comprises a vibrating motor; and
the flexible member defines a receiving groove configured for receiving the vibrating motor.

7. The massaging device according to claim 1, further comprising:
a printed circuit board, the driving assembly is electrically connected with the printed circuit board; and
a wireless communication module, electrically connected with the printed circuit board to control the driving assembly.

8. The massaging device according to claim 1, further comprising:
an outer housing, the flexible member is received in the outer housing; or at least a portion of the flexible member is exposed from the outer housing.

9. The massaging device according to claim 1, wherein
the massaging device further comprises an inner housing connected with the flexible member; and
the driving assembly comprises:
a driving member;
a gear set, connected with the driving member;
a screw rod, connected with the gear set and defining a guiding groove, the guiding groove is spirally or aslant defined on the screw rod; and
a limiting member, fixedly connected with the inner housing and extended in the guiding groove, the driving member is configured to drive the gear set and the screw rod to rotate, the limiting member is configured to move in the guiding groove and move the inner housing and the flexible member to reciprocate due to an interaction between the limiting member and an inner wall of the guiding groove.

10. The massaging device according to claim 9, further comprising:
a support housing;
at least one guiding rod, arranged on the support housing;
a first seat, arranged on the inner housing, the limiting member is fixedly arranged on the first seat; and
a second seat, connected with the first seat, the first seat and the second seat cooperatively define a receiving space for receiving the screw rod, the second seat, the first seat are configured to reciprocate along the guiding rod.

11. The massaging device according to claim 9, wherein the screw rod defines at least two guiding grooves extending along different directions, the at least two guiding grooves comprises at least one junction, and the limiting member is received in the junction.

12. The massaging device according to claim 1, wherein
the massaging device comprises an inner housing connected with the flexible member; and
the driving assembly comprises:
a driving member;
a worm, rotatably connected with the driving member;
a turbine, engaged with the worm;
at least one rotating plate, fixedly connected with the turbine; and
at least one swing rod, connected with the rotating plate, the driving member is configured to drive the worm, the turbine, the rotating plate and the swing rod to rotate, to move the inner housing and the flexible member to reciprocate.

13. The massaging device according to claim 1, further comprising:
an outer housing;
at least one guiding rod, arranged on the outer housing; and
at least one movable seat, fixedly connected with the inner housing, the movable seat is slidably connected with the guiding rod, and the flexible member, the inner housing, and the movable seat are configured to reciprocate along the guiding rod.

14. The massaging device according to claim 1, further comprising:
an inner housing, connected with the flexible member;
a first sleeve;
a second sleeve, connected with the first sleeve, and the second sleeve and the first sleeve cooperatively define a guiding groove, the guiding groove is spirally or aslant defined between the first sleeve and the second sleeve, the inner housing is received in the first sleeve and the second sleeve; and
a limiting member, arranged on the inner housing, the driving assembly is configured to drive the first sleeve and the second sleeve to rotate, the limiting member is configured to move in the guiding groove and move the inner housing and the flexible member to reciprocate due to an interaction between the limiting member and an inner wall of the guiding groove.

15. The massaging device according to claim 14, wherein the driving assembly comprises:
a driving member;
a first gear, rotatably connected with the driving member; and
a second gear, engaged with the first gear and connected with the first sleeve, the driving member is configured to drive the first gear and the second gear to rotate, to move the first sleeve, the second sleeve, the inner housing, and the flexible member to reciprocate.

16. The massaging device according to claim 14, wherein
the inner housing defines at least one limiting groove, the limiting member is received in the limiting groove; and
the massaging device further comprises an outer housing, the outer housing comprises at least one limiting column, the limiting column is received in the limiting groove, the inner housing is slidably connected with the outer housing by a cooperation between the limiting groove and the limiting column.

17. The massaging device according to claim 14, wherein
the first sleeve comprises a first curved edge;
the second sleeve is internally provided with a second curved edge, when the first sleeve is received in the second sleeve, the first curved edge and the second curved edge cooperatively define the guiding groove.

18. The massaging device according to claim 1, further comprising:
a fixing housing; and
a movable frame, connected with the inner housing, the movable frame and the inner housing are movably received in the fixing housing, the driving assembly is arranged on the movable frame and configured to drive the movable frame and inner housing to reciprocate.

19. The massaging device according to claim 18, wherein
the fixing housing defines a sliding groove; and
the driving assembly comprises:
a driving member, mounted on the movable frame;
a worm, connected with the driving member;
a turbine, connected with the worm;
a first gear, connected with the turbine;
a second gear, engaged with the first gear; and
a follower, arranged on the second gear, the follower is slidably received in the sliding groove to move the inner housing, the flexible member and the movable frame to reciprocate.

20. The massaging device according to claim 18, wherein
the movable frame comprises a first sub movable frame configured for mounting the first gear and the second gear, and a second sub movable frame detachably connected with the first sub movable frame, the second sub movable frame is configured for mounting the driving member and the worm; and
the massaging device further comprises at least one guiding member fixedly connected with the fixing frame, the guiding member defines a sliding groove, an edge of first sub movable frame and/or an edge of second sub fixing frame is movably received in the sliding groove.
